(19) United States
(12) Patent Application Publication
(10) Pub. No.: US 2004/0222183 A1
(43) Pub. Date: Nov. 11, 2004

(54) Method of forming an electrically conductive pattern on support

(76) Inventor: Urho A. Pietila, Helsinki (FI)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/845,236

(22) Filed: May 14, 2004

Related U.S. Application Data
(63) Continuation-in-part of application No. 10/168,535, filed on Jul. 1, 2002, now Pat. No. 6,750,894.
Application No. 10/168,535 is a 371 of international application No. PCT/FI01/00005, filed on Jan. 3, 2001.

(30) Foreign Application Priority Data
Jan. 3, 2000 (FI) 20000005
Aug. 28, 2000 (FI) 20001892
Jan. 26, 2004 (FI) 20040107

(51) Int. Cl. H01B 13/00

(52) U.S. Cl. 216/13

(57) ABSTRACT

The present invention relates to a method of forming a conductive pattern in accordance with an object pattern onto a substrate. In the method, the pattern first defined as the numerical image values at its coordinate locations and then, using these numerical values, the final pattern is recorded with the help of reactive agents capable of undergoing a change of state. The state-changing reactive agents is applied onto each point of said substrate in an amount located and controlled by said numerical value of the respective point in the object pattern, whereupon each one of said amounts of said applied agents is subjected to a reaction causing a change of state. The invention can be implemented to product printed-circuit boards and similar conductive patterns.

### CROSS REFERENCE TO RELATED APPLICATIONS

This application is a Continuation-in-Part of U.S. Ser. No. 10/168,535 of 7 Jan. 2002, filed as PCT/FI01/00005 on Jan. 3, 2001.

### BACKGROUND OF THE INVENTION

1. Field of the Invention

The present invention relates to a method of forming an electrically conductive pattern in conformity with an object pattern onto a substrate.

2. Description of the Related Art

In the art it is known a method in printed-circuit manufacture which is build on the masking technique based on photography. In this approach, a blank board, is clad over its entire surface area with a conducting material such as copper, as well as with a photoreactive covering layer. The board is then exposed through a mask representing the conductive pattern to be manufactured. The exposed areas of the covering layer undergo to a change of state forming a protective layer for the areas of the blank which should remain in the subsequent etching procedures to remove the conductive material from the unexposed areas of the boards.

One modification of this technique is to first print the pattern, using ink-jet technology for instance, onto the clad board surface. To produce such as a pattern, the material to be deposited is selected such that it can be converted after its application into a form capable of protecting the underlying conducting material during the work-step wherein the unprotected areas of the conducting cladding material is chemically removed from the board surface. The protective printed-circuit mask is advantageously applied using a photoreactive material such as a light-curable polymer.

### BRIEF SUMMARY OF THE INVENTION

The method is based on an image transfer technique, wherein the object pattern to be manufactured is first determined in its two dimensional, alternatively three dimensional numerical parameters. Using these numerical values, the final pattern is then recorded with the help of reactive agents capable of undergoing a change of state. Advantageously, the reactive agent forming the image of the pattern by a state change is a photoreactive agent, particularly advantageously an agent capable of undergoing a photoreactive conversion into a specific state, including conductive state, with the help of which the final pattern is recorded in a shape and configuration that represent those of the original object pattern.

To obtain the required digital pattern image values, the object can be first imaged by a plurality of techniques known in the art, such as a direct photography of the object using a digital camera. Alternatively, the object may be first photographed in a conventional manner and the information content of the film image thus formed can be converted into a digital format by means of scanners generally used in the art.

The pattern to be manufactured can also to be determined directly in digital form with proper calculations.

Obviously, an image stored in a digital format can be subjected to intermediate processing by different methods known in the art.

### DETAIL DESCRIPTION OF THE PREFERRED EMBODIMENTS

According to the general concept of the invention, the reactive agent capable of a state change is applied onto a substrate in amounts positioned and controlled by the numerical value associated with the respective coordinate location, whereupon the substrate can be subjected to a reaction resulting in the desired state change in the applied agent.

The invention may be implemented in an advantageous manner using known kinds of photoreactive materials that are employed in the art of photography. In these materials, the photoreactive component is generally a silver halide mixed in a suitable matrix material (gelatin), whereby an emulsion is formed containing the photo-reactive component. The physical qualities of the emulsion such as its rheology properties can be controlled in a conventional manner by way of selecting a proper matrix material and then modifying its properties with the help of additives, for instance. Also temperature level control can be used to affect the flowability and reactivity of the emulsion.

The substrate material, whereon the pattern image is reproduced may be any material conventionally used in the art that can be subjected to a proper pretreatment required by the applied reactive component.

Advantageously, the equipment used for applying the state-changing reactive material onto the substrate is based on ink-jet droplet deposition of the printing ink material, but also other known pixel-by-pixel controlled printing techniques can be used such as those based on an electrical force of attraction.

In the ink-jet printing technique, the application of the state-changing reactive material can be controlled on the basis of the numerical values imaged from the object pattern. As to the definition of image recording process, the essential factors are the dot size and spatial density of applied dots. The equipment used in the application of the state-changing reactive material may be complemented with different kinds of auxiliary functions such as temperature control and mixing of the reactive material. According to an embodiment of the invention, the photoreactive material used in printing may be pre-exposed prior to its application onto the substrate, which means that the exposing means may be integrated with the ink application apparatus.

The image formed by application of the photoreactive material onto the substrate is a latent image meaning that the photoreactive material has been converted by an exposure into a form wherein it can undergo a reaction producing its specific state. In the processing of the latent image, the exposure of the photoreactive material is not critical. As the pixels have no excess amount of the photoreactive material, the exposure is carried out as an overexposure thus assuring that all the photo-reactive material is converted into a latent image form. Underexposure must be avoided, because if not all the photoreactive material is not exposed, the formation of the latent image will remain incomplete.

The conventional technique of changing the latent image into a visible form, that is, conversion into the specific color of the photoreactive material takes place via a chemical reaction. In the art of photography, this step is known as development. For photoreactive materials based on silver halides, the developer must be a reducing agent. Obviously, the type of developer must be selected according to the kind of photoreactive material used.

Developing can be made in all the known fashions in a liquid phase, but also a developer carried in a steam or gas phase may be used. In terms of environmental burden, the latter techniques are preferred. After developing, the image is subjected to a normal washing step, complemented with conventional postprocessing steps such as glazing if necessary and coatings.

The developer used to bring about the so-called explicit print may be incorporated in the coating preapplied onto the substrate, whereby the pattern will form immediately after the ink-jet application of the photoreactive material with the provision that the photoreactive material is pre-exposed or, alternatively, after the ink-jet application and exposure steps if the photoreactive material is not pre-exposed before the ink-jet application step.

In implementations of the invention, the state-changing reactive material, whose application takes place in a digitally controlled manner, can be deposited in liquid form such as an emulsion, but depending on the choice of most appropriate deposition technique, the reactive material may also be applied in gas or steam phase with the provision that the positioning of the material onto the substrate is controlled with the help of a compatibly controlled deposition technique such as any of those based on an electrically controlled attraction force. Obviously, any combination of these deposition techniques may be used.

The basic concept of the invention may also be applied in conjunction with materials others than those having photoreactive properties with the provision that the chemical or physical state of such materials after their deposition onto a substrate can be changed by a chemical or physical treatment.

When the invention is implemented in conjunction with the manufacture of printed-circuit boards, it is advantageous to use a combination of compounds in a liquid or emulsion form, wherein one of the components is a molecular-level compound that, by means of a chemical reaction, advantageously a photochemical reaction, can be converted into a form having chemical affinity with conducting compounds. An example of such a compound is, for instance, a silver halide such as silver bromide embedded in a suitable matrix such as gelatin as is known from the art of photography.

In more detail, the above embodiment of invention is carried out by recording a printed-circuit pattern onto the printed-circuit substrate using a numerically controlled ink-jet deposition technique. If the reactive component is a silver halide, its chemical affinity is initiated by a photochemical reaction and finally the pattern is converted into metallic silver by a chemical reduction reaction. After washing, the board is placed in an electrolytic bath, wherein the conducting compound is electrolytically deposited onto the silver pattern developed onto the board surface. The electrolytic bath may have a composition containing a copper compound.

An alternative embodiment of the invention in printed-circuit manufacture may be carried out by first coating a circuit board substrate, such a blank polyester laminate, with a photoreactive emulsion having a protective film overlying the same, whereby the unexposed form of the emulsion has an adhesive nature. Next, the circuit pattern is deposited onto the protective film using a material that is opaque to light or at least can be made opaque. Such a patterning material can be, e.g., a silver halide emulsion, whereon the circuit pattern is formed as a latent image. The final circuit pattern is made opaque to light by developing the latent image by a reduction reaction of the silver halide.

Next, the circuit board substrate is exposed to convert the exposable portion of the photoreactive emulsion applied onto the substrate into a different state, wherein the emulsion loses its adhesive property. In contrast, the areas of the emulsion protected by the pattern of developed silver retain their adhesive property. Now these protected areas define the desired circuit pattern. Subsequently, the protective film can be peeled off from the surface of the circuit board substrate, whereby the thus defined areas of the emulsion remain on the printed-circuit substrate forming the circuit conductors as a pattern of tacky areas. Now, these surface areas may be treated with a finely pulverized dust of a conducting material, such as copper dust, which adheres to the tacky areas and provides a high-definition circuit pattern for final processing.

In one embodiment of the invention, an electrically conductive pattern is formed on a substrate by defining the pattern on the substrate using a silver halide as the state-changing reactive component. The reactive component is deposited on the substrate, for instance using the ink-jet technology, in accordance with the measures described above. The material deposited as the pattern on the substrate is exposed, and the latent image developed thereafter by treating the material with a reducing chemical. It has been shown that the metallic silver remaining in the pattern can achieve an electrically conductive path with a sufficient low resistance for several printed circuit applications.

In the last mentioned application of the invention care must be taken in selecting the silver compound, especially the content of the silver halide in the compound is to be high, above the level of the contents in materials used in common photography. Some special film materials for professional photography applications have proven to include silver halide contents on sufficient level. Experiments have been conducted using Ilford Nuclear emulsion research plate, and developing the exposed pattern with Ilfobrom hydroquinone developer. After usual fixing and washing steps the pattern was noted to conduct electricity (resistance of the used pattern 0.6 ohms).

The amount of the silver halide at a certain point in the pattern can be taken into account according to the embodiment of the invention where the pattern is determined in tree dimension fashion, i.e. the thickness or height of the pattern in different points is taken in account.

1. A method for the manufacture of an electrically conductive pattern in accordance with an object pattern onto a substrate comprising:
first defining the two dimensional configuration of the object pattern as numerical values further comprising coordinate locations and then forming the final pattern on the substrate in state-changing reactive agents capable of undergoing a change of state by
applying the state changing reactive agent onto each point of said substrate in an amount according to a numerical pattern value at the respective corresponding point in the object pattern, and
subjecting the amounts of said applied agent to a reaction causing a change of state of all of the reactive agent.

2. The method according to claim 1, characterized in that said state-changing reactive agent is an irradiation-reactive agent.

3. The method according to claim 2, characterized in that said state-changing reactive agent is a photoreactive agent.

4. The method according to claim 1 or 2, characterized in that said state changing reactive agent is an agent capable of undergoing a conversion into electrically conductive state.

5. The method according to claim 2 or 3, characterized in that said state-changing reactive agent is exposed after its application onto the substrate.

6. The method according to claim 2 or 3, characterized in that said state-changing reactive agent is exposed prior to its application onto the substrate.

7. The method according to claim 3, characterized in that said change of state is accomplished by means of treating the formed latent pattern with a chemical composition.

8. A method for the manufacture of an electrically conductive pattern in accordance with an object pattern onto a substrate comprising:
first defining the three dimensional configuration of the object pattern as numerical values further comprising thickness values at coordinate locations and then forming the final pattern on the substrate in state-changing reactive agents capable of undergoing a change of state by
applying the state changing reactive agent onto each point of said substrate in an amount according to a numerical pattern value at the respective corresponding point in the object pattern, and
subjecting the amounts of said applied agent to a reaction causing a change of state of all of the reactive agent.

9. The method according to claim 8, characterized in that said state-changing reactive agent is an irradiation-reactive agent.

10. The method according to claim 9, characterized in that said state-changing reactive agent is a photoreactive agent.

11. The method according to claim 8 or 9, characterized in that said state changing reactive agent is an agent capable of undergoing a conversion into electrically conductive state.

12. The method according to claim 9 or 10, characterized in that said state-changing reactive agent is exposed after its application onto the substrate.

13. The method according to claim 9 or 10, characterized in that said state-changing reactive agent is exposed prior to its application onto the substrate.

14. The method according to claim 10, characterized in that said change of state is accomplished by means of treating the formed latent pattern with a chemical composition.

15. A method for the manufacture of printed-circuit boards, comprising:
printing a circuit board pattern onto the circuit board substrate with a reactive material that, by means of a chemical reaction, is convertible into a form having chemical affinity with a conducting compound;
initiating the chemical reaction to convert the reactive material; and
electrolytically depositing the conductive compound onto the circuit board pattern.

16. The method according to claim 15, wherein the reactive component comprises a silver halide, the chemical reaction is a photochemical reaction, and metallic copper is electrolytically deposited onto the circuit board pattern.

17. The method according to claim 15, wherein the silver halide is silver bromide embedded in a matrix.

18. A method for the manufacture of printed-circuit boards, comprising:
providing a circuit board substrate;
covering the substrate with a photoreactive adhesive emulsion to light, whereby the emulsion loses an adhesive property thereof to light in areas exposed to light and retains the adhesive property in areas not exposed to light;
treating the areas not exposed to light with a dust of a conducting material which adheres to the tacky areas; and
processing the conducting material to provide a circuit pattern.
